(19) United States
(12) Patent Application Publication
(10) Pub. No.: US 2008/0060204 A1
(43) Pub. Date: Mar. 13, 2008

(54) Magnetic knife holder

(76) Inventor: Kuo-Chang Chen, Hsi Kang Hsiang (TW)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/519,001

(22) Filed: Sep. 12, 2006

(51) Int. Cl. B26B 27/00

(52) U.S. Cl. 30/298.4

(57) ABSTRACT

A magnetic knife holder has an elongated body having a surface with a flat bottom, two sides, a top and a front, multiple magnet recess formed in the surface of the body, multiple magnets respectively mounted in the magnet recesses and multiple knife slots formed longitudinally in the front of the body for receiving knives. With magnetic attraction force provided by the magnets, knives can be held securely in the knife slots in the body to avoid spilling out of the knife slots when the body is inadvertently turned over and the body can be conveniently attached to a metallic furniture. Additionally, at lease one of the sides and the top of the body is flat such that multiple magnetic knife holders can be neatly juxtaposed or stacked up together.

### BACKGROUND OF THE INVENTION

1. Field of the Invention

The present invention relates to a knife holder, and more particular to a magnetic knife holder.

2. Description of Related Art

With reference to FIG. 8, a conventional knife holder (90) comprises a tilting body (91). The tilting body (91) is substantially a rectangular block and has a bottom surface, a top surface, a support wedge (93) and multiple knife slots (911). The support wedge (93) is formed integrally on the tilting body (91) and has a bottom surface flush with the bottom surface of the tilting body (91) to stably support the tilting body (91) on a flat object. The knife slots (911) are formed parallel in the top surface of the tilt body (91) for receiving knives (92).

The knife holder (90) is placed on a worktop and allows a user to take and use the knives (92) conveniently. However, the knife holder (90) does not provide a feature of stably holding the knives (92) in the knife slots (911). So, the knife holder (90) is easily and inadvertently turned over to cause the knives (92) spilling out of the knife slots (911) and hurting people. The knife holder (90) does not have acceptable safety in use.

Further, the knife holder (90) is limited to be placed on a flat worktop and has a low versatility.

### SUMMARY OF THE INVENTION

The primary objective of the present invention is to provide a magnetic knife holder to obviate and mitigate the aforementioned problems.

The magnetic knife holder comprises an elongated body having a surface, multiple magnet recess, multiple magnets and multiple knife slots. The surface of the body has a flat bottom, two sides, a top and a front. At lease one of the sides and the top of the body is flat. Therefore, multiple knife holders are capable of being juxtaposed or stacked up together by abutting their flat sides or tops together. The magnet recesses are formed in the surface of the body. The magnets respectively correspond to and are mounted in the magnet recesses in the surface of the body. The knife slots are formed longitudinally in the front of the body for receiving knives.

With magnetic attraction force provided by the magnets, the knives are held securely in the knife slots in the body to avoid spilling out of the knife slots when the body is inadvertently turned over, and safety in use of the knife holder is accordingly raised.

Additionally, with magnetic attraction force provided by the magnets, the magnetic knife holder can be attached to any metallic furniture, does not need to occupy space on a worktop and raises versatility of using the knife holder.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a preferred embodiment of a magnetic knife holder in accordance with the present invention;

FIG. 2 is a front view in partial section of the magnetic knife holder in FIG. 1;

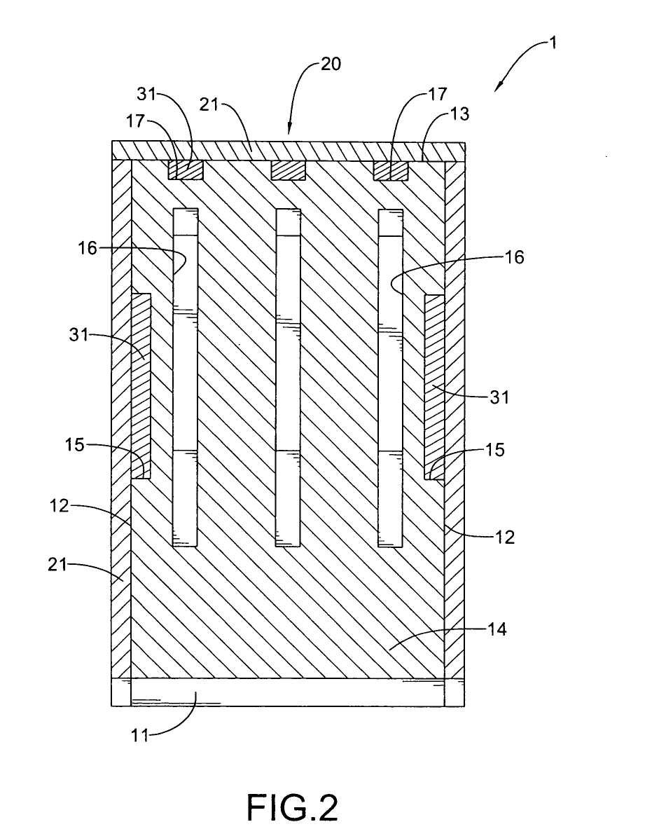

FIG. 3 is an operational perspective view of the magnetic knife holder in FIG. 1 with a knife received in a knife slot;

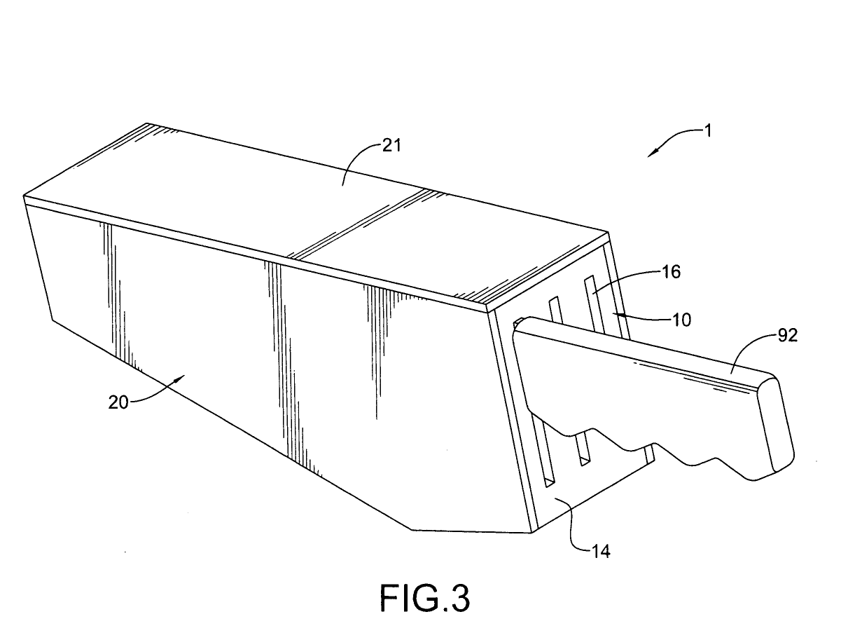

FIG. 4 is an operational perspective view of the magnetic knife holder in FIG. 1 with a knife being attracted by magnets in the magnetic knife holder; and

FIG. 5 is a perspective view of multiple magnetic knife holders in accordance with the present invention juxtaposed together;

FIG. 6 is a perspective view of two magnetic knife holders in accordance with the present invention stacked together;

FIG. 7 is a perspective view in partial section of multiple knife holders in accordance with the present invention respectively attached on a worktop and a bottom and a front of a cabinet; and

FIG. 8 is an operational perspective view of a conventional knife holder in accordance with the prior art.

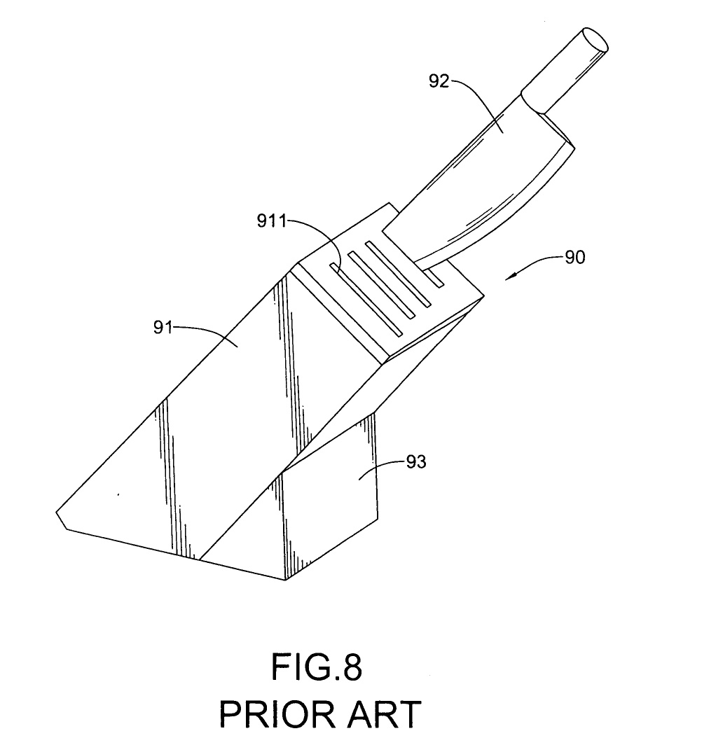

### DETAILED DESCRIPTION OF THE PREFERRED EMBODIMENT

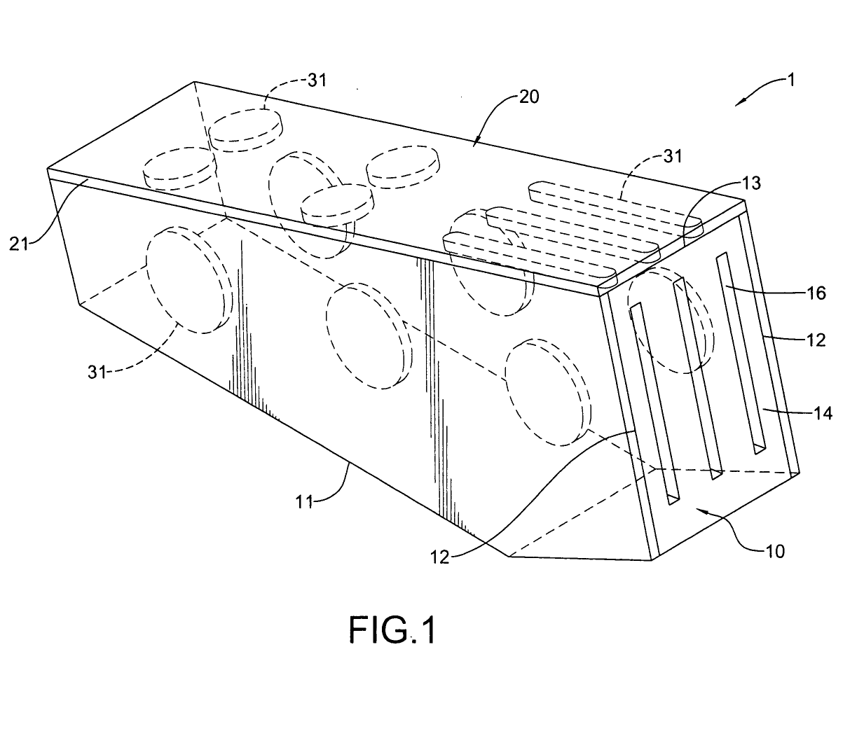

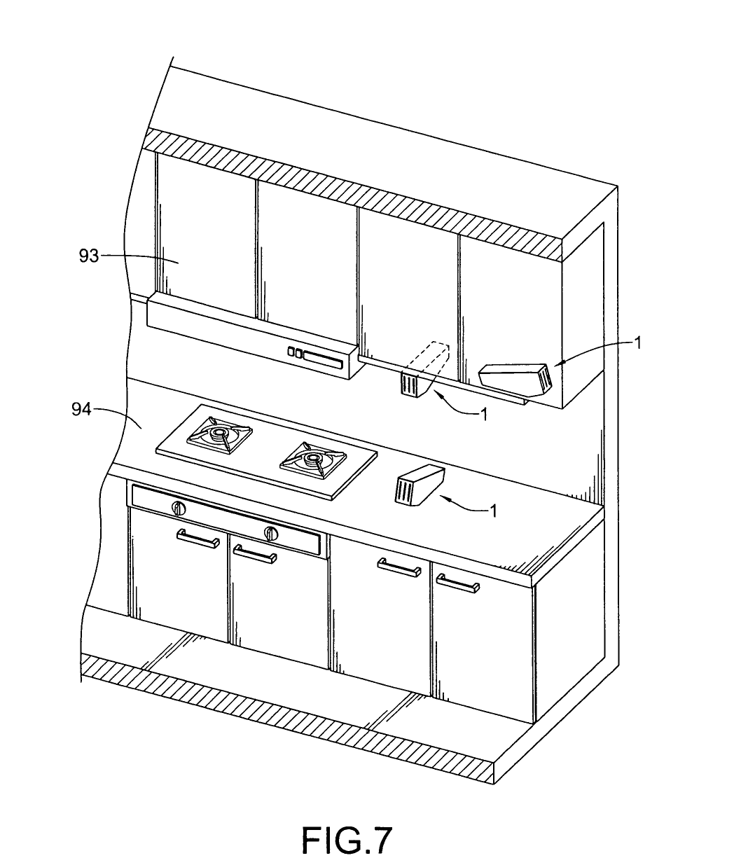

With reference to FIGS. 1 and 7, a magnetic knife holder (1) comprises a body (10) and an optional cover assembly (20).

The body (10) is elongated and has a surface, multiple magnet recesses (15, 17), multiple magnets (31) and multiple knife slots (16).

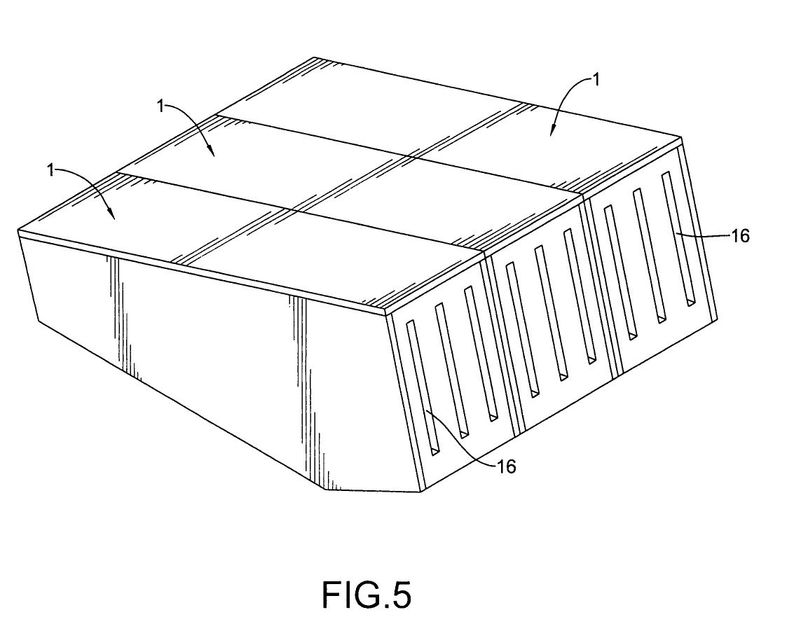

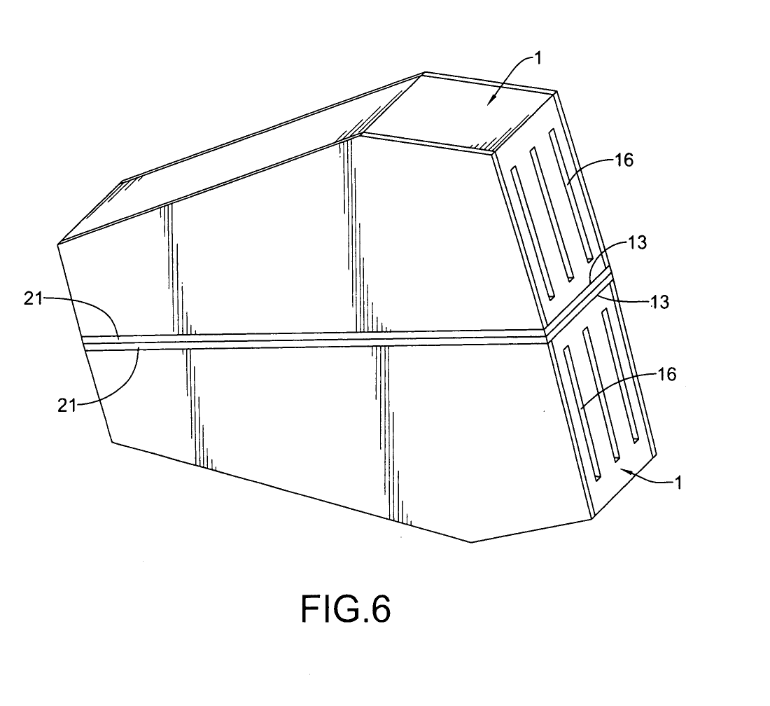

The surface of the body (10) has a bottom (11), two sides (12), a top (13) and a front (14). The bottom (11) of the surface of the body (10) is flat so that the body (10) can be placed on a worktop (94). At least one of the sides (12) and the top (13) on the surface of the body (10) is flat. Therefore, with further reference to FIGS. 5 and 6, multiple bodies (10) of magnetic knife holders (1) can be neatly juxtaposed together or stacked up.

In a preferred embodiment of the body (10), the sides (12) and the top (13) of the surface of the body (10) are all flat.

The magnet recesses (15, 17) are formed in the surface of the body (10), may be formed respectively in the sides (12) and the top (13) of the body (10) and may include multiple elongated magnet recesses (17). The elongated magnet recesses (17) are formed longitudinally in the top (13) of the body (10) and parallel to each other.

The magnets (31) respectively correspond to and are mounted in the magnet recesses (15, 17) in the surface of the body (10). Therefore, the body (10) can be conveniently attached to a bottom or a front of a cabinet (93) or a metallic furniture by magnetic attraction force to improve a versatility of using the magnetic knife holder (1).

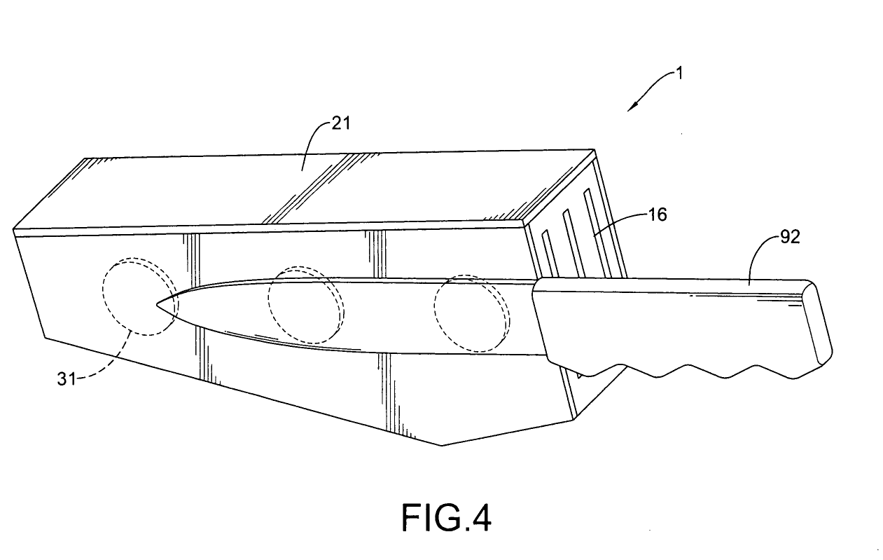

Additionally, with further reference to FIG. 4, a user, during cooking, can temporarily attach a knife (92) to the surface of the body (10) by magnetic attraction force provided by the magnets (31) rather than placing the knife on the worktop (94). Thus, the knife (92) does not be contaminated by dirt on the worktop (94).

The knife slots (16) are formed longitudinally in the front (14) of the body (10) for receiving knives (92) and may respectively align with the elongated magnet recesses (17) in the top (13) of the body (10).

Knives (92) can be securely received in the knife slots (16) by the magnetic attraction force provided by the magnets (31), even if the body (10) is inadvertently turned over, the knives (92) does not spill out from but are still held in the knife slots (16). Thus, a safety in use of the magnetic knife holder (1) is assured.

The cover assembly (20) is mounted on the surface of the body (10) to cover the magnets (31) in the magnet recesses (15, 17) to keep the body (10) having a neat appearance. The cover assembly (20) may have three cover panels (21). The cover panels (21) respectively correspond to and are mounted on the sides (12) and the top (13) of the body (10).

The magnetic knife holder (1) has following advantages:

1. Safety In Use: Knives (92) can be securely held in the knife slots (16) in the body (10) by magnetic attraction force, even if the body (10) is inadvertently turned over to protect people from being injured.

2. Sanitation: During cooking, a cook can temporarily put knives (12) on the surface of the body (10) to avoid contaminating dirt on the worktop (94).

3. Higher versatility: the magnetic knife holder (1) can be conveniently attached to any metallic furniture. Accordingly, the magnetic knife holder (1) does not occupy any space on the worktop (94) and raise the versatility of using the holder (1).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A magnetic knife holder (1) comprising:
a body (10) being elongated and having
a surface having
a bottom (11) being flat;
two sides (12);
a top (13); and
a front (14);
multiple magnet recesses (15, 17) formed in the surface of the body (10);
multiple magnets (31) respectively corresponding to and mounted in the magnet recesses (15, 17) in the surface of the body (10); and
multiple knife slots (16) formed longitudinally in the front (14) of the surface of the body (10);
wherein at lease one of the sides (12) and the top (13) of the surface of the body (10) is flat.

2. The magnetic knife holder (1) as claimed in claim 1 further comprising a cover assembly (20) mounted on the surface of the body (10) to cover the magnets (31) in the magnet recesses (15, 17).

3. The magnetic knife holder (1) as claimed in claim 1, wherein
the sides (12) and the top (13) of the surface of the body (10) are all flat; and
the magnet recesses (15, 17) are formed respectively in the sides (12) and the top (13) of the surface of the body (10).

4. The magnetic knife holder (1) as claimed in claim 3, wherein
the magnet recesses (15, 17) include multiple long magnet recesses (17). formed longitudinally in the top (13) of the surface of the body (10) and parallel to each other; and
the knife slots (16) respectively align with the long magnet recesses (17).

5. The magnetic knife holder (1) as claimed in claim 3 further comprising a cover assembly (20) mounted on the surface of the body (10) to cover the magnets (31) in the magnet recesses (15, 17).

6. The magnetic knife holder (1) as claimed in claim 5, wherein the cover assembly (20) has three cover panels (21) respectively corresponding to and mounted on the sides (12) and the top (13) of the surface of the body (10).
